(19) United States
(12) Patent Application Publication
(10) Pub. No.: US 2017/0085426 A1
(43) Pub. Date: Mar. 23, 2017

(54) SYSTEM AND METHOD FOR PREPROCESSING USER APPLICATIONS

(71) Applicant: Alibaba Group Holding Limited, George Town (KY)

(72) Inventor: Zhonghua Zeng, Hangzhou (CN)

(73) Assignee: Alibaba Group Holding Limited, George Town (KY)

(21) Appl. No.: 15/267,608

(22) Filed: Sep. 16, 2016

(30) Foreign Application Priority Data
Sep. 22, 2015 (CN) 201510608413.2

(51) Int. Cl. H04L 12/24; H04L 29/08

(52) U.S. Cl. CPC H04L 41/0816; H04L 67/22; H04L 41/0886

(57) ABSTRACT

One embodiment of the present invention provides a system for pre-configuring applications installed on a client device. During operation, the system collects contextual information associated with a user of the client device, and determines whether a pre-configuration condition for an inactive application is met based on the collected contextual information and a set of pre-configuration rules. In response to the pre-configuration condition being met, the system pre-configures the inactive application, without receiving an instruction from the user.

### RELATED APPLICATION

Under 35 U.S.C. §119, this application claims the benefit and right of priority of Chinese Patent Application No. 201510608413.2, filed 22 Sep. 2015.

### BACKGROUND

Field

The present application relates to configuration of user applications on client devices. More specifically, the present application relates to a system and method that can pre-configure/process user applications based on contextual information.

Related Art

Rapid development in the mobile technologies has fundamentally changed people's lives, including how we interact with each other and how we conduct daily activities. Mobile applications, also known as apps, are computer programs designed to run on mobile devices (e.g., smartphones and tablet computers), and have enabled users to obtain information (e.g., reading news), access entertainment (e.g., playing games or streaming audio and video files), conduct business (e.g., responding to emails or paying bills), etc.

Many mobile apps are built based on client-server architecture, where one or more client devices request information from a server device. During operation, client devices can send requests to a server via a network, and the server can respond to the clients with the requested information via the network.

A user can start an app by entering a command at the client device. For example, a user can tap an icon displayed on the touchscreen of a smartphone to start an application program installed on the smartphone. Once started, the application program may need to connect to the corresponding server program running on the server to obtain information. For example, if the application is for forecasting weather, once started, the weather app will connect to the server to obtain the most up-to-date weather information in order to display this data on the client device. However, if the server is overloaded with requests or if the client device experiences poor signal strength, downloading the necessary information may takes a long time and can lead to a bad user experience.

### SUMMARY

One embodiment of the present invention provides a system for pre-configuring applications installed on a client device. During operation, the system collects contextual information associated with a user of the client device, and determines whether a pre-configuration condition for an inactive application is met based on the collected contextual information and a set of pre-configuration rules. In response to the pre-configuration condition being met, the system pre-configures the inactive application, without receiving an instruction from the user.

In a variation on this embodiment, the contextual information comprises one or more of: time, geographic location, ambient light information, ambient sound information, network condition, weather condition, movement trace, and body posture of the user.

In a variation on this embodiment, pre-configuring the application comprises one or more of: downloading data needed for running the application from a remote server, and running the application on the client device in the background.

In a variation on this embodiment, the system derives the pre-configuration rules based on contextual information collected within a training period.

In a further variation, the system updates the pre-configuration rules based on recently collected contextual information associated with the user.

In a variation on this embodiment, the system determines whether the client device is coupled to a wireless local area network (LAN) in response to the pre-configuration condition not being met. In response to determining that the client device is coupled to a wireless LAN, the system determines whether a secondary pre-configuration condition is met, and the system pre-configures the inactive application in response to the secondary pre-configuration condition being met.

In a variation on this embodiment, collecting the contextual information is performed in response to one of: a predetermined timer condition being met, a main display of the client device being turned on, a change in geographic location of the client device, and a change in network connectivity of the client device.

### BRIEF DESCRIPTION OF THE FIGURES

FIG. 1 presents a time-state diagram illustrating an exemplary client-server process of a news mobile app.

FIG. 2 presents a diagram illustrating an exemplary user-application pre-configuration system, in accordance with one embodiment of the present invention.

FIG. 3 presents a diagram illustrating an exemplary client device, in accordance with an embodiment of the present invention.

FIG. 4 presents the pseudocode for obtaining the GPS positioning data, according to one embodiment of the present invention.

FIG. 5A presents a table listing launching statistics for a news app collected in a day, in accordance with an embodiment of the present invention.

FIG. 5B presents a table listing launching statistics for a news app collected in a different day, in accordance with an embodiment of the present invention.

FIG. 6A presents a diagram illustrating exemplary statistics associated with launching time, in accordance with an embodiment of the present invention.

FIG. 6B presents a diagram illustrating exemplary statistics associated with launching time and location, in accordance with an embodiment of the present invention.

FIG. 7 presents a diagram illustrating an exemplary application pre-configuration engine, according to one embodiment of the present invention.

FIG. 8 presents a flowchart illustrating an exemplary application pre-configuration process, in accordance with an embodiment of the present invention.

FIG. 9A shows exemplary pseudocodes for a timer-controlled pre-configuration process, in accordance with an embodiment of the present invention.

FIG. 9B shows exemplary pseudocodes for performing a pre-configuration process, in accordance with an embodiment of the present invention.

FIG. 9C shows exemplary pseudocodes for performing a pre-configuration process, in accordance with an embodiment of the present invention.

FIG. 9D shows exemplary pseudocodes for performing a pre-configuration process, in accordance with an embodiment of the present invention.

FIG. 10 presents a flowchart illustrating an exemplary application pre-configuration process, in accordance with an embodiment of the present invention.

FIG. 11 illustrates an exemplary computer system 1100 that facilitates pre-configuration of applications, in accordance with one embodiment of the present invention.

In the figures, like reference numerals refer to the same figure elements.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

### Overview

Embodiments of the present invention provide a system and method for pre-configuring/processing user applications based on contextual data to enhance user experiences. More specifically, each time a user starts an application, the system can collect contextual data, including time, location, network environment, ambient sound and light information, etc. Over time, the system can then derive a user-behavior model based on the collected contextual data. By applying the user-behavior model, the system can predict whether a user is about to start an application based on the current contextual data, and can pre-configure/process the to-be-opened application, which can include pre-downloading, from the server to a buffer zone on the client device, necessary information for the user application. Therefore, when the user starts the application, the application can obtain the necessary information directly from the buffer, thus significantly reducing the application response time.

### Pre-Configuration of User Applications

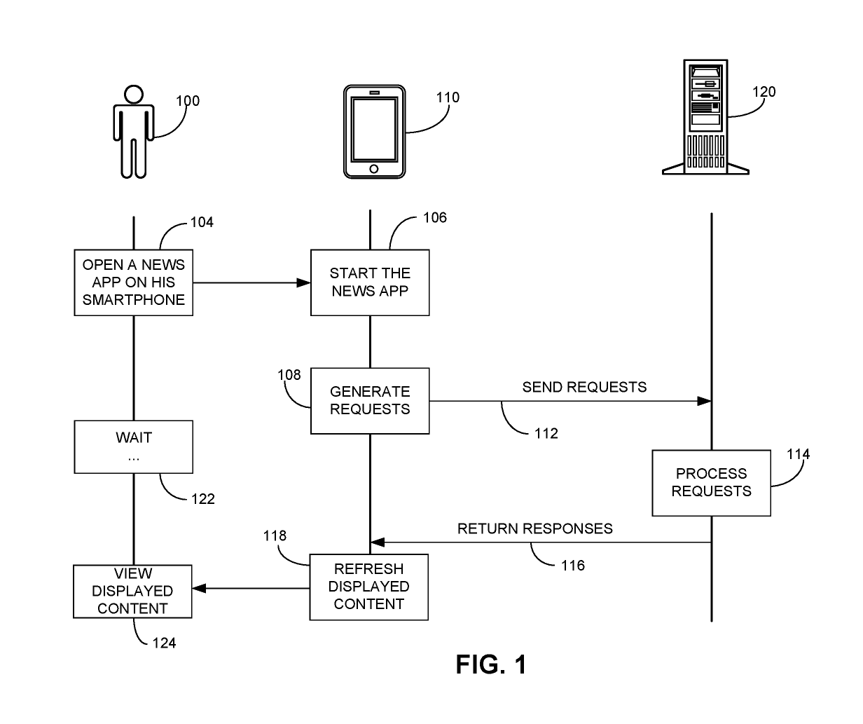

FIG. 1 presents a time-state diagram illustrating an exemplary client-server process of a news mobile app. At a certain time of the day (e.g., seven o'clock in the morning), a user 100 may decide to get the news by opening a news app on his smartphone 110 (operation 104). In response, smartphone 110 starts the application program (operation 106). In order to refresh news content displayed on the client interface, smartphone 110 generates and send requests (e.g., HTTP requests) to news server 120 (operations 108 and 112).

Upon receiving the requests, news server 120 processes the requests (operation 114) and returns responses (e.g., content to-be-displayed) to smartphone 110 (operation 116). Smartphone 110 refreshes its displayed content (operation 118). In the meantime, user 100 waits for smartphone 110 to update its display (operation 122) before he can view the refreshed content on the display of smartphone 110 (operation 124).

As one can see from FIG. 1, before user 100 can enjoy the news app, he needs to wait for the request-response process to be completed by smartphone 110 and news server 120. Under normal conditions (e.g., smartphone 110 is coupled to the internet via a high-speed connection, the link between smartphone 110 and server 120 functions normally, server 120 is not congested, etc.), user 100 may only need to wait briefly (e.g., for less than one second) before viewing the updated news content. However, if the network or server 120 is congested, user 100 may have to wait for a long time before being able to view the news update. In such scenarios, user 100 may become tired of waiting and close the news app, and the news app misses a chance to service user 100. If this happens frequently, user 100 may no longer use the news app, meaning that the app company may lose a customer.

To overcome this problem, in some embodiments of the present invention, the system can pre-configure an application (e.g., downloading from the server content needed for running or updating the application) before the user actually opens the application. The downloaded content can be temporarily stored in a buffer zone (e.g., in the memory of a smartphone). When the user starts the application (e.g., by tapping a corresponding icon on the touchscreen), the content needed for the application to run or to refresh its display can be directly downloaded from the memory instead of from the remote server. This way, the user can start enjoying the application (e.g., viewing the updated news) immediately, and have a satisfying experience.

In addition to pre-configuring certain mobile applications to improve user experience, embodiments of the present invention can also be implemented in the smart-homes technology or the internet of things (IoT) technology. For example, a wearable device attached to a user (e.g., a smartwatch) can collect information regarding the user's movements (e.g., direction, speed, movement trace, etc.) to determine that the user intends to open the door of the home refrigerator, and send such information, over the home network or the internet, to the control unit of the refrigerator. The control unit can then pre-configure the client side application running on the refrigerator, which can in turn open the refrigerator door for the user as the user approaches the refrigerator.

Since many applications provide time-sensitive information to users, such as news, weather forecasts, etc., it can be preferable for the system to pre-configure the application right before the user starts the application. Downloading the content too early (e.g., hours before the user starts the application) may result in the user not being able to view the most up-to-date content when he starts the application. One way to ensure that the user can view the most up-to-date content whenever he starts the application is to perform periodic downloading, over short intervals (e.g., every five minutes). However, such an approach can consume too much power and too much bandwidth, making it undesirable for mobile devices.

To provide user satisfaction without wasting power or bandwidth, in some embodiments of the present invention, the system makes predictions about the time a user will start an application, and pre-configures the application a short time (e.g., minutes) before the user starts the application to allow the user to enjoy the application the instant he launches the application (e.g., by taping on the application icon on the touchscreen). In order to predict when the user will start the application, the system needs to develop an application-related behavior model of the user; to do so, the system needs to collect contextual data each time the user starts an application.

### User-Behavior Model

One important parameter of the application-related user-behavior model is the starting time of an application, i.e., the time instant when the user opens the application on his mobile device. Depending on the type of application, the starting time can be an absolute time or a time that is relative to other parameters, such as locations or network settings. If the starting time is an absolute time, parameters of the user-behavior model can include the app-starting time and the period or frequency of the user's app-starting action. For example, the user may start a news app every morning at around 7:30, and the user-behavior model can include the starting time as 7:30 AM and the frequency as daily. Other than daily usage, a user's usage habit of certain apps may take on other forms. For example, the usage frequency can be once a week, a month, or a year. For example, an app specially designed to find deals on “Black Friday” may only be launched once every year.

In addition to the absolute time, a user's app usage behavior can also correlate with other types of contextual information, such as geographic location, ambient light and sound, weather condition, network condition, etc. Again using the news app as an example, a working adult may choose to read news during the day, utilizing various time fragments, such as during lunch or while riding the train or bus to and from work. Therefore, the associated user-behavior model can include the geographic location (e.g., the train station or restaurant). Moreover, a dating app may often be opened by the user in a social setting, such as a bar, and the user-model related to the dating app can include parameters such as ambient light and sound.

To establish the application-related user model, the system can collect contextual information associated with the user while running the application. The contextual information can be collected at the server end or at the client end by a mobile device or a smart terminal. In some embodiments, establishing a user-behavior model associated with an application can involve a training period. During the training period, the system collects contextual information each time the user launches the application. The contextual information can include, but is not limited to: application launch time, geographic location, network condition, voice information, ambient light and sound information, etc. The training period can last for days, weeks, or months, depending on the usage frequency of the application.

Once sufficient usage statistics and associated contextual information are obtained, the system can process the usage statistics and contextual information to obtain the user-behavior model. In some embodiments, based on the user-behavior model, the system can derive a set of pre-configuration rules, specifying one or more pre-configuration conditions. During normal operation, if one or more pre-configuration conditions are met, the system can pre-configure the application. In some embodiments, pre-configuring an application can involve downloading data from the application server.

### User-Application Pre-Configuration System

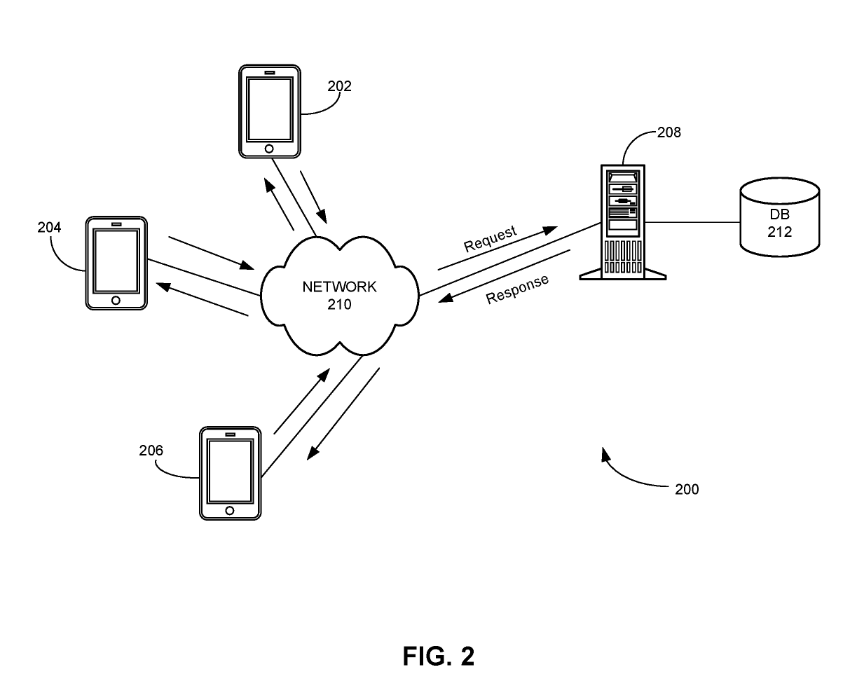

FIG. 2 presents a diagram illustrating an exemplary user-application pre-configuration system, in accordance with one embodiment of the present invention. User-application pre-configuration system200 includes a number of client devices (e.g., devices 202, 204, and 206) coupled to a server 208 via a network 210. Server 208 can also be coupled to a database 212.

Client devices 202-206 can include any type of computing devices, including but not limited to: smartphones, laptop computers, tablet computers, desktop computers, wearable devices, smart terminals, etc. Examples of the smart terminals can include smart home appliances. In some embodiments, the client devices can also include cloud computing terminals, which offload most computing tasks to the cloud. The client devices can send requests to server 208 via network 210.

Network 210 can include various types of wired to wireless networks. In some embodiments, network 210 can include the public switched telephone network (PSTN) and the internet. Alternatively, network 210 can include wireless communication networks, such as a Global System for Mobile communications (GSM) network, a Long Term Evolution (LTE) network, a wireless local area network (LAN), etc.

Server 208 can include a network server, preferably a cloud server. Server 208 can send responses to the client devices, in response to requests from the client devices. In some embodiments, server 208 can receive application statistics from the client devices, derive application pre-configuration rules, and return the application pre-configuration rules to client devices.

After the initial installation of an application, the client devices and/or server 208 can collect, during a training period (which can be days, weeks, or months), contextual information associated with the user each time the application is launched and establish a user-behavior model. In some embodiments, a set of pre-configuration rules can be established based on the user-behavior model. The pre-configuration rules specify one or more pre-configuration conditions.

Subsequent to the establishment of the pre-configuration rules, the system can continue to collect contextual information associated with the user, while the application is not running. The system can determine, based on the collected user contextual information, whether a pre-configuration condition is met. If so, the system can pre-configure the application without receiving any explicit or implicit request from the user. More specifically, the pre-configured application can start downloading data from server 208 and buffer the downloaded data, without receiving the user's command for launching the application. This way, when the user launches the application subsequently, the application can obtain the previously downloaded data directly from the local buffer without needing to request such data from the server, thus allowing the user to enjoy the application instantly.

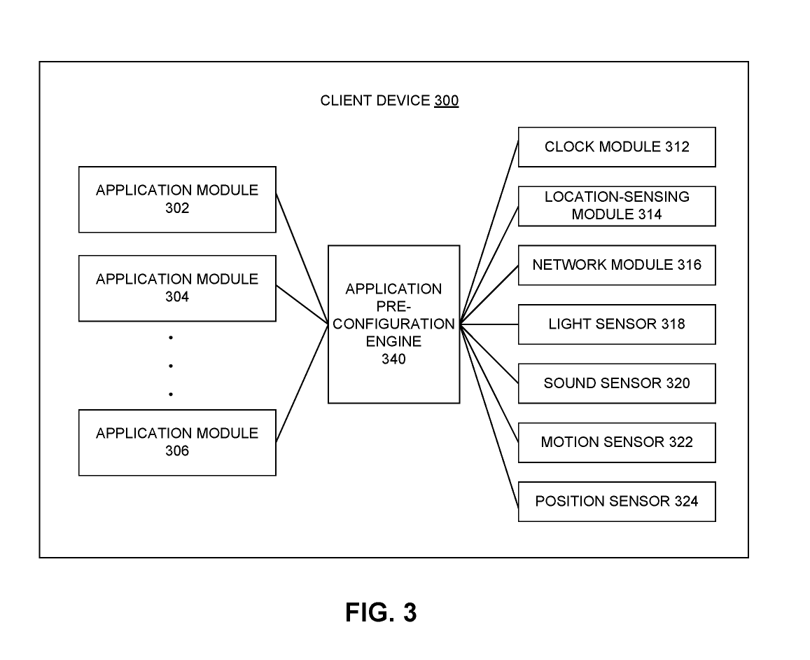

FIG. 3 presents a diagram illustrating an exemplary client device, in accordance with an embodiment of the present invention. Client device 300 can include a number of application modules (e.g., modules 302-306), a number of sensor modules (e.g., a clock module 312, a location-sensing module 314, a network module 316, a light sensor 318, a sound sensor 320, a motion sensor 322, a position sensor 324, etc.), and an application pre-configuration engine 340. Some modules can include software, some modules can include hardware, and some modules can include a combination of software and hardware.

The application modules can include any types of client side applications, such as mobile applications and cloud applications. When an application is running on client device 300, it can communicate with a remote server to obtain data to be presented to the user.

When an application module is initially installed on client device 300, application pre-configuration engine 340 can monitor the usage of the application modules and collect contextual information from the various sensor modules. In some embodiments, the application usage monitoring and contextual information collecting can last for a predetermined time period, also known as a training period. The duration of the training period can depend on the types of applications, more particularly their usage frequencies. For application modules with high usage frequencies, the training period can be shorter. In some embodiments, the duration of the training period associated with an application can be set such that the application is launched at least multiple (e.g., 10 or more) times during a training period to ensure that enough contextual information has been collected.

In some embodiments, application pre-configuration engine 340 can obtain, from clock module 312, the time of launching of an application and/or the duration that the application remains active. During a training period, the application can be launched by the user multiple times, and application pre-configuration engine 340 can obtain launching time statistics by recording each launch time.

Similarly, application pre-configuration engine 340 can obtain, from location-sensing module 314, the geographic location of client device 300 when an application is launched. During a training period, the application can be launched by the user multiple times, and application pre-configuration engine 340 can obtain launching location statistics by recording the geographic location of client device 300 at each launching instant.

There are different ways to express a geographic location; some are more accurate than others. In some embodiments, the location is provided as geographic latitude and longitude values. In some embodiments, the location is provided as an address, which can be a street address, a ZIP code, a location area code (LAC), a tracking area code (TAC), or a district identifier. Geographic latitude and longitude values can provide a higher resolution positioning. On the other hand, the ZIP code, LAC, TAC, or district identifier often provides lower resolution positioning, representing a large area. The street address, on the other hand, may provide different levels of resolutions, depending on its completeness. An incomplete address (e.g., an address that only states the country, state, city, and name of street) can also represent an area of a certain size.

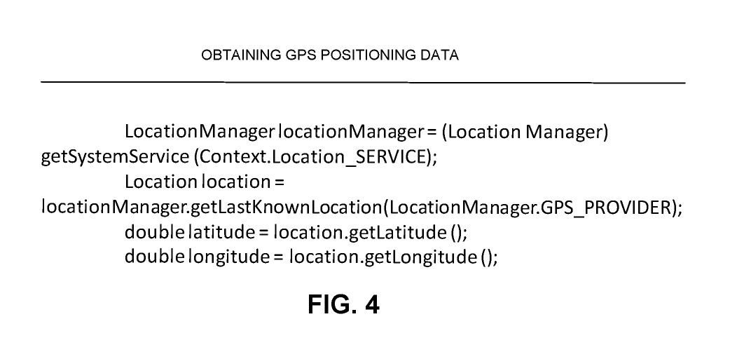

In some embodiments, location-sensing module 314 can include a receiver of a global navigation satellite system (GNSS), such as the Global Positioning System (GPS) receiver or the BeiDou Navigation Satellite System (BDS) receiver. When an application is launched, application pre-configuration engine 340 can read positioning data from the GPS or BDS receiver, thus obtaining the geographic locations, often in the form of latitude and longitude values. When combined with a map (either locally stored or accessible from a remote server), the positioning data can be converted into a street address. FIG. 4 presents the pseudocode for obtaining the GPS positioning data, according to one embodiment of the present invention. The variables “latitude” and “longitude” shown in FIG. 4 are the geographic latitude and longitude of a location.

Returning to FIG. 3, if client device 300 is not equipped with a GNSS receiver, location-sensing module 314 can determine the location of client device 300 based on the current LAC (for the GSM network), TAC (for the LTE network), or district identifier assigned to the client device by the network. Note that the LAC, TAC, or district identifiers can be distributed to client device 300 when client device 300 registers with a network or changes locations within the network. In general, high-resolution positioning (e.g., by using a GPS receiver) can enable the establishment of more accurate user-behavior models, thus making it possible for application pre-configuration engine 340 to make a more appropriate pre-configuration decision. However, the scope of the instant application is not limited by the method or system used for location determination.

Application pre-configuration engine 340 can also obtain, from network module 316, the network condition of client device 300 when an application is launched. In some embodiments, each time the application is launched, network module 316 records various types of information associated with the network, to which client device 300 is connected. The network information can include, but is not limited to: types of the network (e.g., 2G, 3G, or wireless LAN) and the bandwidth of the network. If the currently connected network is a wireless LAN, such as a Wi-Fi network, the network information can also include the Wi-Fi hotspot identifier.

Other sensors, such as light sensor 318 and sound sensor 320, can also provide various types of environmental information to application pre-configuration engine 340. For example, light sensor 318, which can include a camera or other devices that can sense the intensity and/or spectrum of the ambient light, can record the current ambient light information each time the application is launched. Similarly, sound sensor 320, which can include a microphone, can record ambient sound. In some embodiments, a voice recognition module can be used to analyze the recorded sound to extract characteristics of the ambient sound, also known as the acoustic fingerprint. The acoustic fingerprint can sometimes be used to identify a particular location. Application pre-configuration engine 340 can collect launching statistics associated with the ambient light and sound during the training period.

In addition to light and sound, other environmental factors, such as the weather condition at the time the application is launched, can also be collected by application pre-configuration engine 340. For example, application pre-configuration engine 340 can interface with a app to obtain the current weather condition.

Motion sensor 322 and position sensor 324 can provide information associated with movements and positions of client device 300 to allow application pre-configuration engine 340 to collect statistics corresponding to the movements and positions during a training period. If client device 300 is a wearable device, such as a smartwatch, the movements and positions of client device 300 can correspond to a user's body movements (e.g., lifting an arm).

In addition to the sensor modules shown in FIG. 3, application pre-configuration engine 340 can also interact with any other types of sensor modules equipped by client device 300 to obtain other types of contextual information each time an application is launched. Other than sensor modules, application pre-configuration engine 340 can also interact with the various application modules (e.g., application modules 302-306) to obtain contextual information associated with the launching of a particular application. In some embodiments, application pre-configuration engine 340 can also obtain, from a remote server, the various types of contextual information (e.g., location, network condition, ambient light and sound, etc.) associated with the launching of a particular application. The remote server can also include a cloud server. The large data storage capacity and processing power of a cloud server can ensure that more detailed contextual information can be provided, resulting in a more accurate pre-configuration decision.

Other than collecting contextual information at the instant an application is launched, application pre-configuration engine 340 can continue to collect contextual information while the application is running. For example, while a particular application is running, application pre-configuration engine 340 can collect, at the instant of, before, or after the occurrence of a special event, contextual information associated with the user's behavior (e.g., movement direction, speed, GPS trace, etc.) such that application pre-configuration engine 340 can establish a user behavior model associated with the application. Such a user behavior model can be useful for making a pre-configuration decision.

As previously discussed, the length of the training period can be determined based on the launching frequency of the application. For applications that are launched more frequently, the training period can be shorter. For example, a news app can be launched multiple times during a day, and the training period for the pre-configuration of the news app can be a few days. Because most users' application usage activities tend to follow certain repeated routines (e.g., a daily routine, a weekly routine, a monthly routine, etc.), the system can define a statistics-collection interval, which typically is set as a single period of such a routine. A pre-configuration training period can include multiple continuous or discontinuous statistics-collection intervals. In the example of the news app, a statistics-collection interval can be a day, and a training period can include multiple consecutive or non-consecutive days.

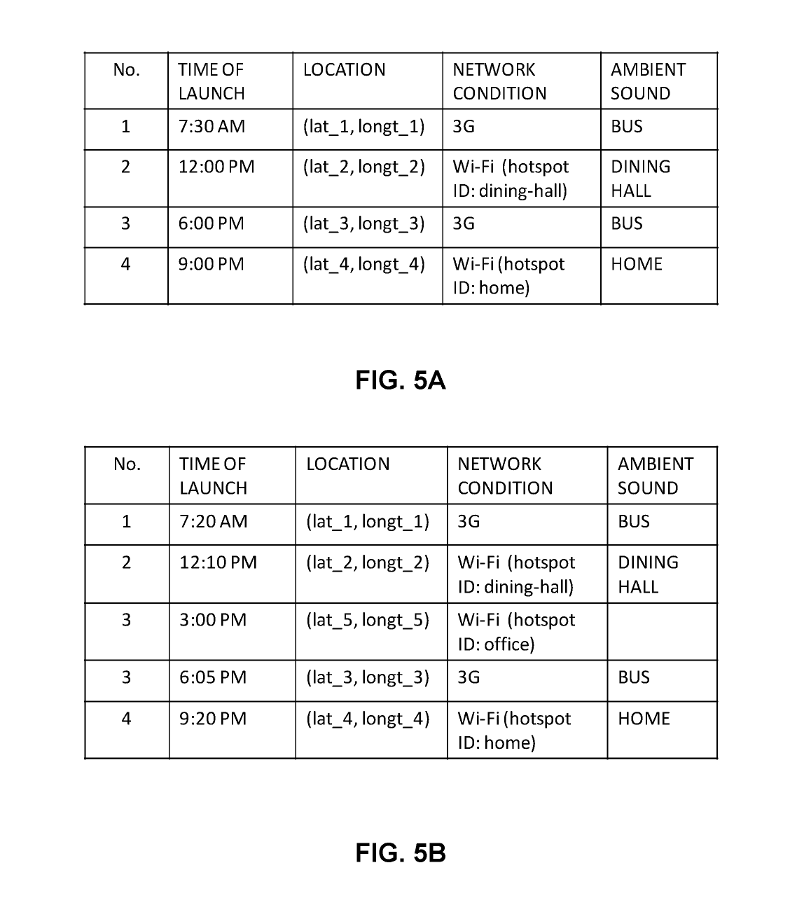

FIG. 5A presents a table listing launching statistics for a news app collected in a day, in accordance with an embodiment of the present invention. One can see from FIG. 5A, on this particular day, the news app is launched four times. The system records, for each launch, the time of launch, the location, the network condition, and the ambient sound. More specifically, the location is expressed using the latitude (e.g., lat_1, lat_2, etc.) and the longitude (e.g., longt_1, longt_2, etc.) values, and the recorded ambient sound has been labeled using a location corresponding to the characteristics of the sound. For example, the ambient sound having characteristics corresponding to the acoustic fingerprint of a bus ride can be labeled “bus.” Similarly, the ambient sound having characteristics corresponding to the acoustic fingerprint of the dining hall can be labeled “dining hall.” From FIG. 5A, one can see that the user launches the news app on the bus ride to and from work, at the dining hall during lunch, and at home.

FIG. 5B presents a table listing launching statistics for a news app collected on a different day, in accordance with an embodiment of the present invention. In the example shown in FIG. 5B, the user launches the news app five times. In addition to launching the news app on the bus ride to and from work, at the dining hall during lunch, and at home, the user also launches the news app at 3 PM when he is in his office.

After launching statistics have been obtained for the training period, the system can derive, using a statistical analysis method or a cluster analysis method, a user behavior model based on the obtained launching statistics. The system can further derive one or more pre-configuration rules based on the user behavior model. For example, based on the launching statistics shown in FIGS. 5A-5B, the system can determine that the user typically launches the news app between 7:00 and 7:30 AM. Accordingly, the system can set up a pre-configuration rule to pre-configure the news app at about 7:00 AM. The launching statistics often can include multiple focused clusters. In some embodiments, a k-means clustering method can be used to identify the focal point of each cluster. Other types of machine learning method can also be used to perform the cluster analysis. Once the data of the launching statistics has been partitioned into the different clusters with the focal point of each cluster identified, the system can derive the application pre-configuration rules accordingly.

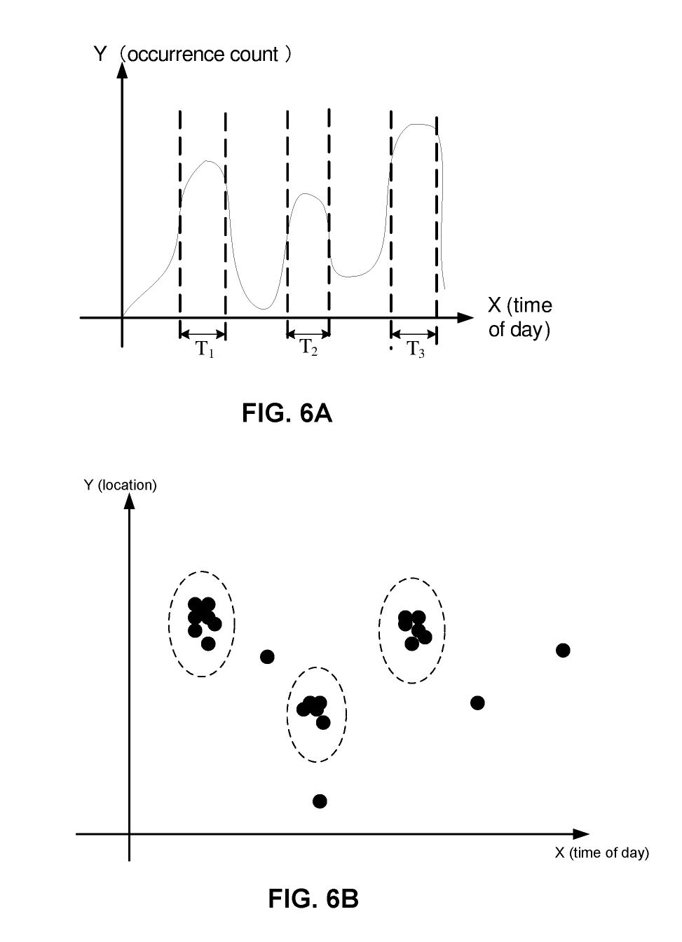

FIG. 6A presents a diagram illustrating exemplary statistics associated with launching time, in accordance with an embodiment of the present invention. More specifically, FIG. 6A shows the launching occurrence count of an application as a function of time. In this example, during a training period, the count of launching occurrences peaks during time intervals T₁, T₂, and T₃. In other words, the user is more likely to launch the application during these three time intervals. Accordingly, the system can derive a pre-configuration rule as follows:

if (time in (T₁, T₂, T₃)): then load_data( ). The above pseudocodes indicate that the pre-configuration rule is set as: if the current time falls within time intervals T₁, T₂, and T₃, the system can pre-configure the application by loading the application data. Note that the X-axis represents the time instants within a statistics-collection interval. If the statistics-collection interval is a day, the time on the X-axis will be the time of day; if the statistics-collection interval is a week, the time will be the time of day plus the day of week.

In addition to the launching time, the location data associated with the application may also include clusters. In the examples shown in FIGS. 5A-5B, the user may launch the application at different locations, such as on a bus, in the dining hall, or at home. The system can analyze the location data and derive a location-based pre-configuration rule, such as

if (location in (home, bus)): then load_data( ). These pseudocodes indicate that the pre-configuration rule is set as: if the current user location is at home or on the bus, the system can pre-configure the application by loading the application data.

In some embodiments, the cluster analysis can be applied to multiple domains. For example, the system can derive a pre-configuration rule based on both the statistics related to the launching time and location. FIG. 6B presents a diagram illustrating exemplary statistics associated with launching time and location, in accordance with an embodiment of the present invention. More specifically, each dot in FIG. 6B represents a launching occurrence, with the position of the dot determined by the time and location associated with the launching occurrence. One can see that the (time, location) data can be clustered, meaning that a user is more likely to launch the application at a particular location during a particular time. For example, a user may launch the news app in his home early in the morning. Although he might remain home at other times, he may not launch the news app. Hence, the appropriate pre-configuration rule can be expressed using pseudocodes:

if (location in (home) and time in (morning)): then load_data( ).

Other environmental factors, in addition to time and location, can also be considered when deriving the pre-configuration rules. Using the data shown in FIGS. 5A-5B as an example, the pre-configuration rules for the news app can specify that the news app will be pre-configured (by loading application data from a remote server) if at least one of the following conditions is met.

Condition No. 1, the current time is between 7:00 and 7:30 AM and the current location of the client device is at (lat_1, longt_1).

Condition No. 2, the current time is between 12:00 and 12:30 PM and the current network to which the client device is connected is a Wi-Fi network named “dining hall.”

Condition No. 3, the current time is between 6:00 and 6:30 PM and the current location of the client device is at (lat_3, longt_3).

Condition No. 4, the current time is between 9:00 and 9:30 PM and the current network to which the client device is connected is a Wi-Fi network named “home.”

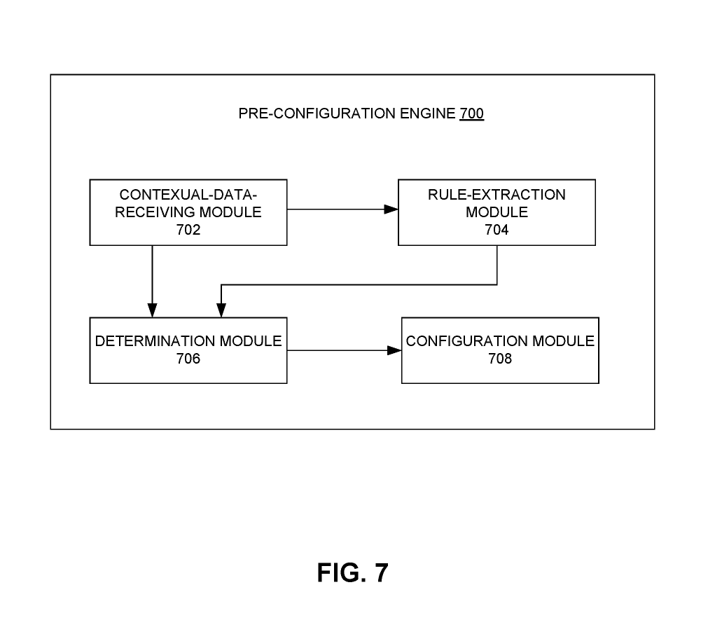

FIG. 7 presents a diagram illustrating an exemplary application pre-configuration engine, according to one embodiment of the present invention. Pre-configuration engine 700 can include a contextual-data-receiving module 702, a rule-extraction module 704, a determination module 706, and a configuration module 708. Contextual-data-receiving module 702 can be responsible for receiving, from various sensors and applications, contextual data associated with the launching of one or more applications. Examples of the contextual data associated with the launching of the applications can include, but are not limited to: the launching time, the location of the client device, the network condition, ambient light and sound, weather condition, etc.

Rule-extraction module 704 can be responsible for extracting pre-configuration rules based on contextual data received during a predetermined training period. In some embodiments, a training period can include multiple statistics-collection intervals that are substantially identical. The length of the statistics-collection interval for a particular application can be determined based on the launching frequency of that application. In general, it is desirable to define a statistics-collection interval that is long enough such that the application is launched at least once (preferably multiple times) during the interval. To ensure that rule-extraction module 704 can extract more accurate pre-configuration rules, the training period should include a sufficient number of statistics-collection intervals. For example, if the statistics-collection interval is a day, the training period can be a few days, a week, or more.

In some embodiments, after extracting an initial set of pre-configuration rules, rule-extraction module 704 can repeat the rule-extraction procedure to update, if necessary, the pre-configuration rules based on newly received contextual data associated with the application. This way, if the user changes his application-usage routine, rule-extraction module 704 can modify the pre-configuration rules in a timely manner. In some embodiments, rule-extraction module 704 can generate or update the pre-configuration rules periodically. The interval between consecutive rule-extraction operations should be no less than the duration of a statistics-collection interval. Alternatively, a rule-extraction operation can be triggered by a special event. For example, if rule-extraction module 704 detects that the user has relocated to a different city, it will perform a rule-extraction operation to update the pre-configuration rules. In addition to location, other environmental changes, such as a change in the network condition, may also trigger rule-extraction module 704 to update the pre-configuration rules.

In some embodiments, rule-extraction module 704 can also update the pre-configuration rules based on manual input from the user. For example, the system can present a user interface to the user to allow the user to change existing pre-configuration rules or generate new pre-configuration rules. For example, a user can specify a time in a time-based pre-configuration rule or a location in a location-based pre-configuration rule. It is also possible for the user to define or adjust other environmental parameters in the pre-configuration rules.

In addition to extracting rules based on various types of contextual information, rule-extraction module 704 can also receive pre-configuration rules from a server or from other client devices. More specifically, a remote server can receive contextual information from the client device, perform the rule-extraction operation, and send the extracted rule back to the client device. Alternatively, a client device can also receive pre-configuration rules from other peers. For example, if a group of users have similar application-usage habits, they can share among them the pre-configuration rules. Similarly, a server can send a set of pre-configuration rules to users within a particular demographic group.

Determination module 706 can be configured to determine, based on current contextual data and the pre-configuration rules, whether one or more pre-configuration conditions are met for an inactive application. For example, determination module 706 can compare the current time with the time(s) specified in the pre-configuration rules or compare the current location of the device with the location(s) specified in the pre-configuration rules. If the time and location meet the requirements of a pre-configuration condition, determination module 706 can then determine that the pre-configuration condition has been met.

Configuration module 708 is responsible for configuring a client side application that is inactive before the user actually launches and activates the application, in response to determination module 706 determining that a pre-configuration condition has been met. The pseudocodes can be written as:

```
if (rule_meet( )){
  load_data( );
  }
```

More specifically, configuration module 708 can start to pre-configure the inactive application without receiving any explicit or implicit instruction or command from the user. Note that, in conventional settings, an inactive application does not consume any resources, including processing, memory, and bandwidth; and there is no communication between the inactive application and the application server. However, pre-configuring the application means that certain resources have been provisioned to the application. In some embodiments, configuring the user application can involve downloading data needed for launching the application from the application server and storing the downloaded data in a temporary buffer (e.g., within the memory) to allow the data to be loaded directly into the application when the user launches the application. For example, if the application is a news app, configuring the application can involve downloading the most up-to-date news from the news server.

In some embodiments, configuring the application can involve running the application on the client device in the background. Note that, running the application in the background can mean that, although the application is running, the user interface of the application is not displayed on the main display of the client device. Alternatively, configuring the application can involve launching the application on a client device and performing certain operations using the application. If the application is used to control the operation of a smart home appliance (e.g., a smart refrigerator or a smart oven), in response to determination module 706 determining that a pre-configuration condition has been met, configuration module 708 can launch the control application installed on the client device to control the operations of the smart home appliance. For example, a wearable device worn by a user can be installed with an application for controlling a smart refrigerator. Based on the location and movements detected by the wearable device, the system can determine that the user is approaching the refrigerator; and based on previously determined pre-configuration rules, which indicate that a pre-configuration condition is satisfied when the user approaches the refrigerator, configuration module 708 pre-configures the refrigerator-control application by launching it on the wearable device. The refrigerator-control application can then control the refrigerator to open the door to allow the user to put food/drink items in or take food/drink items out of the refrigerator. In another example, a wearable device (e.g., a smartwatch) may be able to detect changes in the user's body posture (e.g., raising an arm). Based on the detected body posture and location of the user, the system can determine that the user is raising his right arm and the distance between the user and the refrigerator is less than a predetermined threshold (e.g., 2 m). Accordingly, configuration module 708 can launch the refrigerator-control application on the smartwatch to open the refrigerator's door, because when a user is raising his arm while approaching a refrigerator, the user most likely intends to place items in or take items out of the refrigerator.

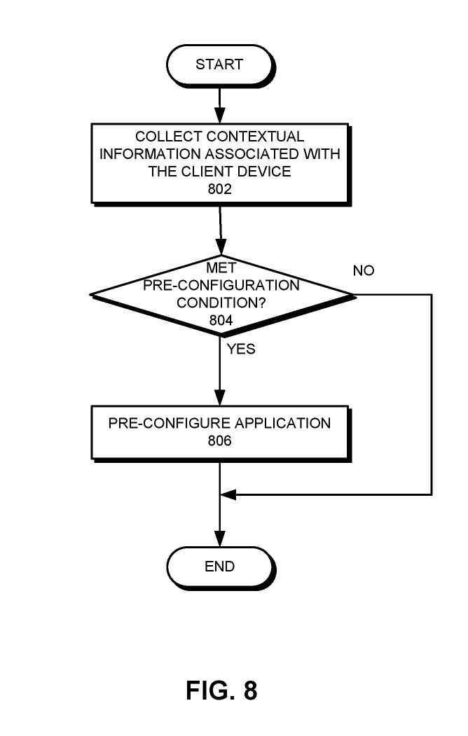

FIG. 8 presents a flowchart illustrating an exemplary application pre-configuration process, in accordance with an embodiment of the present invention. During operation, the system collects contextual information associated with a client device (operation 802). Examples of the client device can include but are not limited to: smartphones, laptop computers, tablet computers, desktop computers, wearable devices, smart terminals, etc. The contextual information can include but is not limited to: time, geographic location, network condition, ambient light and sound, weather, movement, body posture, etc. Subsequently, the system determines whether a pre-configuration condition is met for an application installed on the client device (operation 804). The application is currently inactive or not running on the client device, neither in the background nor in the foreground. In other words, the application does not use any resources, including processor, memory, and network bandwidth. Note that, if multiple applications are installed on the client machine, the system can determine, for each application, whether a pre-configuration condition associated with that application is met. As discussed previously, the pre-configuration condition can be defined by a set of pre-configuration rules that are specific to the application. The pre-configuration rules have been previously established during a training period.

Determining whether a pre-configuration condition is met can involve different determination operations, depending on the particular pre-configuration rule or condition. If a pre-configuration condition is only related to time, the system can compare the current time with the time specified in the pre-configuration condition. If the current time matches or falls within the range of the time specified in the pre-configuration condition, the system determines that the pre-configuration condition has been met. If a pre-configuration condition is only related to location, the system can compare the current location of the client device with the location specified in the pre-configuration condition. If the current location matches or falls within the range of the location specified in the pre-configuration condition, the system determines that the pre-configuration condition has been met. If a pre-configuration condition is related to both the time and location, the system can compare both the current time and current location with the time and location, respectively, specified in the pre-configuration condition. If the current time matches or falls within the range of the time specified in the pre-configuration condition and the current location matches or falls within the range of the location specified in the pre-configuration condition, the system determines that the pre-configuration condition has been met.

If a pre-configuration condition is related to environmental factors, such as ambient light and sound, the system can compare the current ambient light and sound with the ambient light and sound specified in the pre-configuration condition. For example, the system may compare the current light intensity or sound characteristics with the light intensity and sound characteristics, respectively, specified in the pre-configuration condition. If the light intensity is within the light intensity range specified in the pre-configuration condition and the sound characteristics match those specified in the pre-configuration condition, the system determines that the pre-configuration condition has been met.

If a pre-configuration condition is related to both time and environmental factors, the system can compare both the current time and current environmental factors with the time and environmental factors, respectively, specified in the pre-configuration condition. If they both match, the system determines that the pre-configuration condition has been met. Similarly, if a pre-configuration condition is related to both location and environmental factors, the system can compare both the current location and current environmental factors with the location and environmental factors, respectively, specified in the pre-configuration condition. If they both match, the system determines that the pre-configuration condition has been met.

If a pre-configuration condition is related to time, location, and environmental factors, the system can compare the current time, location, and environmental factors with the time, location, and environmental factors, respectively, specified in the pre-configuration condition. If they all match, the system determines that the pre-configuration condition has been met.

If a pre-configuration condition is met, the system pre-configures the corresponding application (operation 806). As discussed previously, pre-configuring an application can involve downloading data needed for launching the application from the application server, running the application on the client device at in the background, or launching the application, without receiving any types (e.g., explicit or implicit) of user instruction or command.

The application pre-configuration process shown in FIG. 8 can be triggered by various events. In some embodiments, the system can set up a timer to periodically perform the pre-configuration process. The period of the timer should be determined based on the usage frequency of the application. Applications that are launched more frequently can have a shorter period. For example, a news app is often launched by the user multiple times a day. To ensure that the system can pre-configure the news app for each launch, the application pre-configuration process may need to be run every 10 minutes or every hour. On the other hand, if an application is launched once a year, the system may only need to run the application pre-configuration process once a month. Moreover, the timer can also be set in such a way that, for the same application, the pre-configuration process can be performed more frequently at certain times. For example, because the user tends to use the news app in the morning or during the lunch hour, the system can perform the pre-configuration process every 10 minutes during these time intervals, and only perform the pre-configuration process every hour at other times. This way, the system reduces the amount of unnecessary computation.

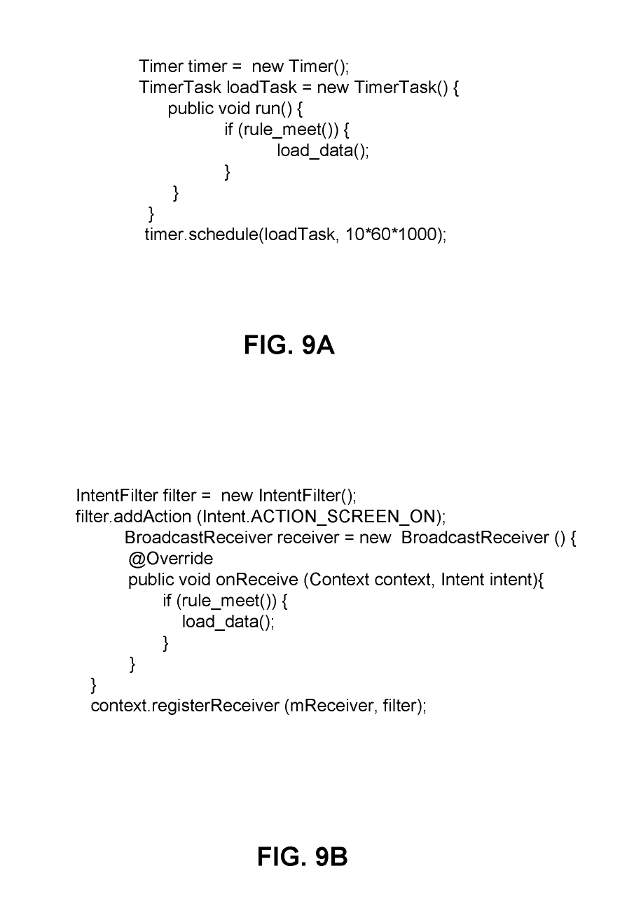

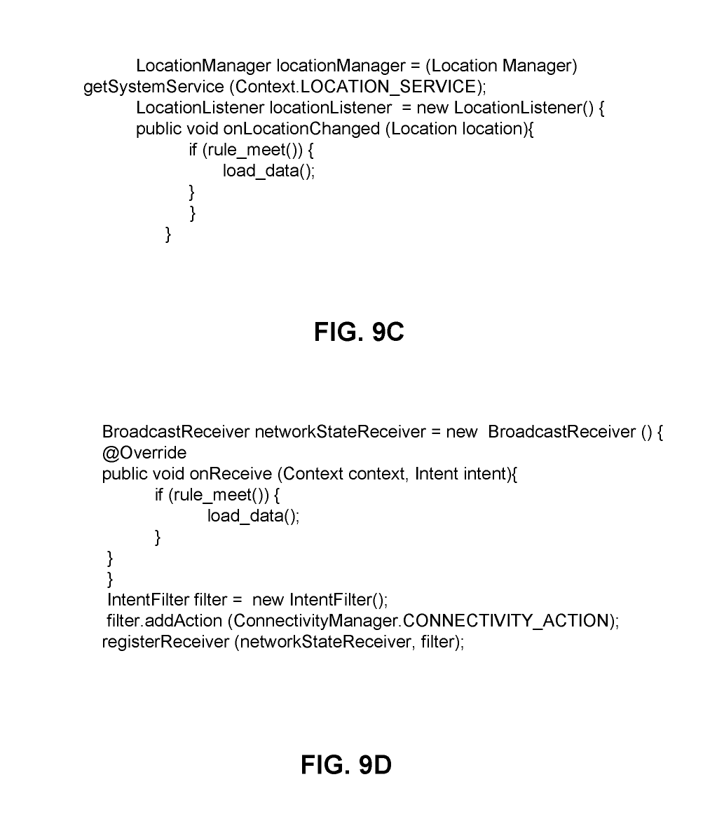

FIG. 9A shows exemplary pseudocodes for a timer-controlled pre-configuration process, in accordance with an embodiment of the present invention. In the example shown in FIG. 9A, the timer is set such that the pre-configuration process is run every 10 minutes.

In addition to a timer, the application pre-configuration process can also be triggered by the detection of a special event. In some embodiments, each time the main display of the client device is turned on or unlocked, the system can perform an application pre-configuration process to pre-configure, if necessary, one or more applications. After a predetermined idle time, for security and power-saving purposes, the main display of the client device can be automatically turned off, and the display screen may also be locked. Turning on the display and unlocking the screen often require the user's explicit action, such as pressing down a button or sliding a finger across the touchscreen, meaning that the user may intend to use an application. By performing the application pre-configuration process, the system can identify an application that the user intends to use and pre-configure the application before the user actually launches the application. Therefore, when the user launches the application, he can enjoy the application immediately without the need to wait for application data to be downloaded from a remote server. FIG. 9B shows exemplary pseudocodes for performing a pre-configuration process, in accordance with an embodiment of the present invention. In the example shown in FIG. 9B, the application pre-configuration process is triggered by the event of turning on the display. In the example shown in FIG. 9B, the system monitors the display, and in response to the screen being turned on, the system performs the application pre-configuration operation.

Alternatively, when the client device relocates from one geographic location to another, the system can also perform an application pre-configuration operation to determine whether a pre-configuration condition for an application has been met. FIG. 9C shows exemplary pseudocodes for performing a pre-configuration process, in accordance with an embodiment of the present invention. In the example shown in FIG. 9C, the system monitors the location of the client device, and in response to a change in the location, the system performs the application pre-configuration operation.

Changes in the network conditions may also trigger the application pre-configuration process. For example, when the client device switches from a cellular network to a Wi-Fi network, the system may also want to check whether any applications need to be pre-configured, because the Wi-Fi network can provide a larger bandwidth and most likely is free. FIG. 9D shows exemplary pseudocodes for performing a pre-configuration process, in accordance with an embodiment of the present invention. In the example shown in FIG. 9D, the system monitors the network connectivity, and in response to a change in the network connectivity, the system performs the application pre-configuration operation.

Because the Wi-Fi network can provide a larger bandwidth and is typically free, it can be beneficial to the user to pre-configure certain applications even if the pre-configuration conditions were not met. In some embodiments, after checking the aforementioned pre-configuration rules and determining that an application does not meet the pre-configuration condition, the system can apply secondary pre-configuration rules if the client device is coupled to a Wi-Fi network. The secondary pre-configuration rules can be more relaxed than the original pre-configuration rules.

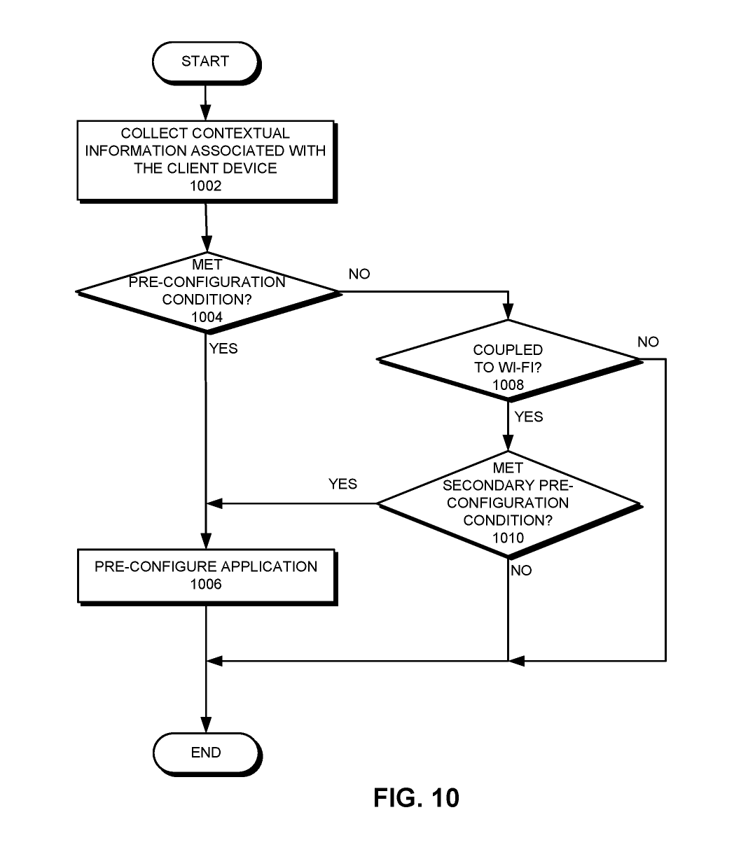

FIG. 10 presents a flowchart illustrating an exemplary application pre-configuration process, in accordance with an embodiment of the present invention. During operation, the system collects contextual information associated with a client device (operation 1002) and determines whether a pre-configuration condition is met for an application installed on the client machine (operation 1004). If so, the system pre-configures the corresponding application (operation 1006). If not, the system determines whether the client device is coupled to a wireless LAN, such as a Wi-Fi network (operation 1008). If the client device is not coupled to a Wi-Fi network, the process ends, and there is no need to pre-configure the application. Otherwise, if the client device is coupled to a Wi-Fi network, the system determines whether a secondary pre-configuration condition is met (operation 1010); if so, the system pre-configures the corresponding application (operation 1006).

In some embodiments, the secondary pre-configuration condition can be a relaxed version of the original pre-configuration condition. For example, if an original pre-configuration condition specifies one or more time intervals, then a corresponding secondary pre-configuration condition can specify a time threshold. If the difference between the current time and the time intervals specified by the original pre-configuration condition is less than the time threshold, the second pre-configuration condition is met. Similarly, if an original pre-configuration condition specifies one or more locations, then a corresponding secondary pre-configuration condition can specify a distance threshold. If the distance between the current location and a location specified by the original pre-configuration condition is less than the distance threshold, the second pre-configuration condition is met. Alternatively, the system can determine, based on the location and movement trace of the client device, whether the user will reach a location specified by the original pre-configuration condition within a predetermined time. If so, the system can consider the secondary pre-configuration to be met.

In general, embodiments of the present invention allow applications installed on a client device to be configured prior to the user actually launching the applications, without receiving any instruction or command from the user. More specifically, the system derives a set of pre-configuration rules for an application based on contextual information collected during a training period associated with the application. Various types of sensors and applications can facilitate the collection of the contextual information. The scope of the instant application is not limited by the types of contextual information used for deriving the pre-configuration rules. Once the pre-configuration rules are established, the system can continue to collect contextual information associated with the client device, and determine whether a pre-configuration condition is met based on the contextual information and the pre-configuration rules. If so, the system can configure the application, which can involve downloading data from a server or running the application in the background. This way, when the user launches the application, the application's user interface can be presented to the user immediately, without the need to wait for application data to be downloaded from a remote server, thus significantly improving the user's experience.

### Computer System

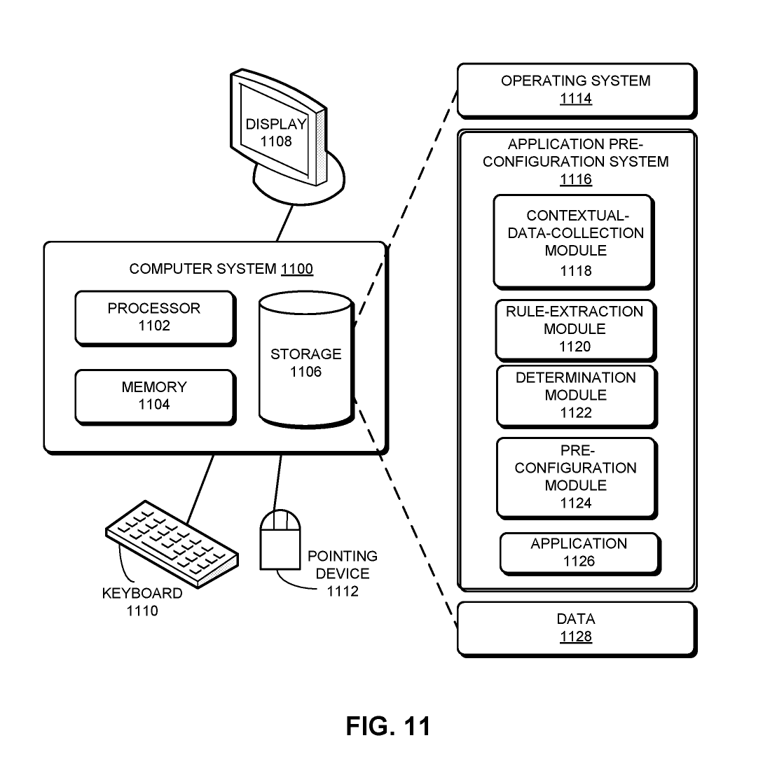

FIG. 11 illustrates an exemplary computer system 1100 that facilitates pre-configuration of applications, in accordance with one embodiment of the present invention. Computer system 1100 includes a processor 1102, a memory 1104, and a storage device 1106. Memory 1104 can include a volatile memory (e.g., RAM) that serves as a managed memory, and can be used to store one or more memory pools. Furthermore, computer system 1100 can be coupled to a display device 1108, a keyboard 1110, and a pointing device 1112. Storage device 1106 can store an operating system 1114, an application pre-configuration system 1116, and data 1128.

Application pre-configuration system 1116 can include instructions, which when executed by computer system 1100, can cause computer system 1100 to perform methods and/or processes described in this disclosure. Specifically, application pre-configuration system 1116 may include instructions for collecting contextual information associated with the user (contextual-data-collection module 1118). Further, application pre-configuration system 1116 can include instructions for extracting pre-configuration rules (rule-extraction module 1120). Application pre-configuration system 1116 can also include instructions for determining whether a pre-configuration condition is met (determination module 1122). Application pre-configuration system 1116 can also include instructions for pre-configuring the applications (pre-configuration module 1124). Application pre-configuration system 1116 can also include one or more applications (e.g., application 1126). Data 1128 can include any data that is required as input or that is generated as output by the methods and/or processes described in this disclosure

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

What is claimed is:

1. A computer-implemented method for pre-configuring applications installed on a client device, comprising:
collecting contextual information associated with a user of the client device;
determining whether a pre-configuration condition for an inactive application is met based on the collected contextual information and a set of pre-configuration rules; and
in response to the pre-configuration condition being met, pre-configuring the inactive application, without receiving an instruction from the user.

2. The method of claim 1, wherein the contextual information comprises one or more of:
time;
geographic location;
ambient light information;
ambient sound information;
network condition;
weather condition;
movement trace; and
body posture of the user.

3. The method of claim 1, wherein pre-configuring the application comprises one or more of:
downloading data needed for running the application from a remote server; and
running the application on the client device in the background.

4. The method of claim 1, further comprising deriving the pre-configuration rules based on contextual information collected within a training period.

5. The method of claim 4, further comprising updating the pre-configuration rules based on recently collected contextual information associated with the user.

6. The method of claim 1, further comprising:
in response to the pre-configuration condition not being met, determining whether the client device is coupled to a wireless local area network (LAN);
in response to determining that the client device is coupled to a wireless LAN, determining whether a secondary pre-configuration condition is met; and
in response to the secondary pre-configuration condition being met, pre-configuring the inactive application.

7. The method of claim 1, wherein collecting the contextual information is performed in response to one of:
a predetermined timer condition being met;
a main display of the client device being turned on;
a change in geographic location of the client device; and
a change in network connectivity of the client device.

8. A non-transitory computer-readable storage medium storing instructions that when executed by a computer cause the computer to perform a method for pre-configuring applications installed on a client device, the method comprising:
collecting contextual information associated with a user of the client device;
determining whether a pre-configuration condition for an inactive application is met based on the collected contextual information and a set of pre-configuration rules; and
in response to the pre-configuration condition being met, pre-configuring the inactive application, without receiving an instruction from the user.

9. The storage medium of claim 8, wherein the contextual information comprises one or more of:
time;
geographic location;
ambient light information;
ambient sound information;
network condition;
weather condition;
movement trace; and
body posture of the user.

10. The storage medium of claim 8, wherein pre-configuring the application comprises one or more of:
downloading data needed for running the application from a remote server; and
running the application on the client device in the background.

11. The storage medium of claim 8, wherein the method further comprises deriving the pre-configuration rules based on contextual information collected within a training period.

12. The storage medium of claim 11, wherein the method further comprises updating the pre-configuration rules based on recently collected contextual information associated with the user.

13. The storage medium of claim 8, wherein the method further comprises:
in response to the pre-configuration condition not being met, determining whether the client device is coupled to a wireless local area network (LAN);
in response to determining that the client device is coupled to a wireless LAN, determining whether a secondary pre-configuration condition is met; and
in response to the secondary pre-configuration condition being met, pre-configuring the inactive application.

14. The storage medium of claim 8, wherein collecting the contextual information is performed in response to one of:
a predetermined timer condition being met;
a main display of the client device being turned on;
a change in geographic location of the client device; and
a change in network connectivity of the client device.

15. A computer system, comprising:
a processor; and
a storage device coupled to the processor and storing instructions which when executed by the processor cause the processor to perform a method for pre-configuring applications installed on a client device, the method comprising:
collecting contextual information associated with a user of the client device;
determining whether a pre-configuration condition for an inactive application is met based on the collected contextual information and a set of pre-configuration rules; and
in response to the pre-configuration condition being met, pre-configuring the inactive application, without receiving an instruction from the user.

16. The computer system of claim 15, wherein the contextual information comprises one or more of:
time;
geographic location;
ambient light information;
ambient sound information;
network condition;
weather condition;
movement trace; and
body posture of the user.

17. The computer system of claim 15, wherein pre-configuring the application comprises one or more of:
downloading data needed for running the application from a remote server; and
running the application on the client device in the background.

18. The computer system of claim 15, wherein the method further comprises:
deriving the pre-configuration rules based on contextual information collected within a training period; and
updating the pre-configuration rules based on recently collected contextual information associated with the user.

19. The computer system of claim 15, wherein the method further comprises:
in response to the pre-configuration condition not being met, determining whether the client device is coupled to a wireless local area network (LAN);
in response to determining that the client device is coupled to a wireless LAN, determining whether a secondary pre-configuration condition is met; and
in response to the secondary pre-configuration condition being met, pre-configuring the inactive application.

20. The computer system of claim 15, wherein collecting the contextual information is performed in response to one of:
a predetermined timer condition being met;
a main display of the client device being turned on;
a change in geographic location of the client device; and
a change in network connectivity of the client device.
